(19) United States
(12) Patent Application Publication
(10) Pub. No.: US 2004/0228987 A1
(43) Pub. Date: Nov. 18, 2004

(54) Ink-jet recording sheet and production method of the same

(75) Inventor: Yoshinori Tsubaki, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/833,842

(22) Filed: Apr. 28, 2004

(30) Foreign Application Priority Data
May 12, 2003 (JP) JP2003-132955

(51) Int. Cl. B41M 5/00

(52) U.S. Cl. 428/32.34

(57) ABSTRACT

An ink-jet recording sheet comprising a support having thereon a porous ink receptive layer which contains inorganic microparticles and a cross-linked resin, wherein the porous ink receptive layer is prepared by a method comprising the steps of: (a) coating a liquid coating composition on the support to obtain a coated layer, the liquid coating composition containing a saponified polyvinyl acetate having a unit represented by General Formula (1) in the molecule; (b) irradiating the saponified polyvinyl acetate in the coated layer with ionization radiation to obtain the cross-linked resin; and (c) drying the coated layer.

### TECHNICAL FIELD

The present invention relates to an ink-jet recording sheet (hereinafter also simply referred to as a recording sheet) and its production method, and in more detail to an ink-jet recording sheet having a porous ink receptive layer which minimizes cracking during production and results in high ink absorbability and exhibits improved image bleeding resistance, folding and fracture resistance.

### BACKGROUND

In recent years, in ink-jet recording systems, image quality has increasingly been improved and is approaching the quality of silver salt photography. As a means to achieve such silver salt photographic quality employing these ink-jet recording systems, technical improvement is increasingly performed for employed recording sheets.

As supports employed for the aforesaid recording sheets, water absorptive supports such as paper, as well as non-water absorptive supports such as polyester film or resin coated paper, are generally known. The former exhibits the advantage of high ink absorption capability since supports themselves can absorb ink. On the other hand, problems occur in which wrinkling (also called cockling) results after printing due to water absorbability of supports, whereby it is difficult to produce high quality prints. In addition, problems occur in which friction tends to occur between the recording head and the print surface, along with the cockling during printing.

When non-water absorptive supports are used, the problems described above do not occur resulting in an advantage of producing high quality prints.

As an example of an improved ink absorptive layer, it was invented an ink-jet recording sheet in which hydrophilic binders such as gelatin or polyvinyl alcohol (PVA) is applied onto a highly smoothed support to form a porous layer. In this type of recording sheet, printed ink is absorbed utilizing swellability of the binders. This type is called as a swell type ink-jet recording sheet.

An ink receptive layer of a swell type sheet has a binder of a water-soluble resin, as a result, ink is not easily dried as desired after printing. In addition, formed images and layers are not sufficiently water resistant. Further, since the printing rate of current ink-jet printers is high, the rate of ink absorption achieved by swelling of binders cannot keep up with the amount and rate of ejected ink. As a result, problems occur in which adaptation for printers is lost to result in ink flooding and images with a mottled appearance.

Japanese Patent Publication Open to Public Inspection (hereinafter referred to as JP-A) No. 63-18387 discloses an ink receptive layer comprising modified polyvinyl alcohol and a water resistant agent. Further, JP-A No. 1-286886 discloses a water-based ink recording sheet comprising a receptive layer prepared by employing a hydrophilic binder which undergoes cross-linking by ionization radiation. By employing hardened binders as a receptive layer, water resistance of images and layers are enhanced as desired. However, since ink is primarily absorbed utilizing swellability of resins, ink absorbability itself is not improved.

Contrary to the type of ink-jet recording sheets which absorb ink utilizing swellability of the aforesaid water-based resins, JP-A No. 10-119423 proposes a paper recording sheet comprising a porous layer having a minute void structure as an ink absorptive layer, resulting in high ink absorbability as well as fast ink drying. Consequently, this method is becoming one of the common methods which result in image quality most similar to that of silver salt photography.

The aforementioned porous layer is mainly formed by employing hydrophilic binders and microparticles. Known as microparticles are inorganic or organic microparticles. However, inorganic microparticles (or called as fine particles) are preferably employed due to realization of a decrease in the particle size and of high glossiness of the porous layer.

Further, by employing hydrophilic binders in a relatively small amount with respect to the aforementioned inorganic microparticles, voids are formed among the inorganic microparticles, whereby a porous layer of a high void ratio results.

Since the aforementioned void portion absorbs ink via capillary phenomenon, it exhibits an advantage in which the absorption rate is not adversely affected even though water resistance is enhanced by cross-linking binders through the simultaneous addition of cross-linking agents. Specifically, in the case of an ink-jet recording sheet which is prepared by providing such a porous layer on a non-water absorptive support such as polyethylene coated paper in which both sides of the paper support are coated with polyethylene resins, during ink-jet recording, it is required that all the ink is temporarily retained in the ink absorptive layer. As a result, it is essential that the ink absorptive layer is one having a high void volume. Consequently, required is forming a coating layer at a high void ratio. The dried layer thickness is customarily at least 25 mm, and is preferably 30-50 μm.

The major component of the porous layer which exhibits such features, is commonly inorganic microparticles which originally form a hard coating layer. Consequently, when a relatively thick porous layer is applied onto a non-water absorptive support, cracking tends to occur during drying.

In the production process of the porous layer, a small amount of hydrophilic binders are adsorbed onto the surface of the inorganic microparticles, whereby inorganic microparticles are intertwined via the aforesaid hydrophilic binders. Alternatively, microparticles are retained via interaction such as with a hydrogen bond among the hydrophilic binders, resulting in formation of a protective colloid, whereby a porous layer is formed. Thereafter, it is assumed that, in the drying process, sudden contraction of the coating results and cracking occurs on the layer surface due to contraction stress. Specifically, the aforesaid phenomena are pronounced near the drying end point of the layer.

Consequently, in order to prepare the desired crack-free coating, it has been required that drying is carried out under relatively mild conditions at the sacrifice of productivity.

Further, in the ink absorptive layer after drying, a problem has occurred in which the water resistance is insufficient since microparticles are bound employing a relatively small amount of hydrophilic binders.

In order to overcome such drawbacks, an ink-jet recording sheet is proposed (refer, for example, to Patent Document 2) in which water resistance of a coating is enhanced employing boric acid as well as an isocyanate based cross-linking agent. Further, an ink-jet recording sheet has been invented (refer, for example, to Patent Document 3) which uses an actinic radiation curing type monomer as a binder. On the other hand, a method is proposed (refer, for example, to Patent Document 4) in which, in an ink-jet recording sheet successively provided with an ink absorptive layer and a gloss generating layer, the aforementioned gloss generating layer is comprised mainly of colloidal particles and a hydrophilic ionization radiation curable compound having at least two ethylenic double bonds in one molecule, and curing is performed by exposure to ionization radiation.

When a cross-linking agent is incorporated into such a binder or an actinic radiation curable monomer is employed as a binder, the water resistance of the dried coating layer is enhanced due to the cross-linking reaction among binders. However, new problems occurred in which flexibility is deteriorated, and in addition, layer folding and fracture resistance was also deteriorated due to the formation of very dense three-dimensional cross-linking among binders relatively close to each other.

Further, Japanese Patent Publication Open to Public Inspection (hereinafter referred to as JP-A) No. 11-157202 describes an example in which a water-soluble resin undergoes cross-linking by use of electron beams. However, when the water-soluble resin undergoes cross-linking by use of electron beams as above, the following problems occur. Since density of inorganic microparticles is generally greater than hydrophilic binders, electron beams are overexposed to hydrophilic binders and solvents whereby the coating surface is roughened due to air bubbles which are formed by instantaneous evaporation of water in the coating. On the contrary, electron beams are not sufficiently exposed to the deep portions of the coating, resulting in a gradient of cross-linking density, whereby only the surface results in a cured layer. Thus, problems occurred in which image bleeding resistance and curl resistance were deteriorated.

(Patent Document 1)

JP-A No. 1-286886 (claims)

(Patent Document 2)

JP-A No. 2001-146068 (claims)

(Patent Document 3)

JP-A No. 7-40649 (claims)

(Patent Document 4)

Japanese Patent No. 3333338 (claims)

### SUMMARY

Subsequently, an object of the present invention is to provide an ink-jet recording sheet having a porous ink receptive layer and the production method of the same. The ink-jet recording sheet has properties of minimized layer cracking during production even with thick layer application and high speed coating. The ink-jet recording sheet exhibits high ink absorbability, high ink bleeding resistance and fracture resistance.

The aforesaid problems of ink-jet recording sheets were solved employing the following structures.

An aspect of the present invention includes an ink-jet recording sheet which is prepared by applying onto a support at least one porous layer comprising inorganic microparticles (or minute inorganic particles) and a hydrophilic resin which has undergone cross-linking by ionization radiation, an ink-jet recording sheet wherein said hydrophilic resin, which undergoes cross-linking by ionization radiation, is a polyvinyl acetate saponification product (or a saponified polyvinyl acetate) having a constitution unit represented by General Formula (1) below.

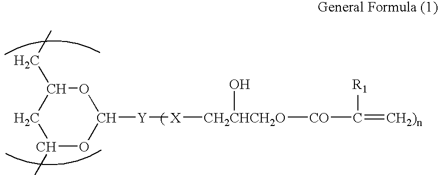

wherein R₁ is a hydrogen atom or a methyl group; n is an integer of 1 or 2; Y is an aromatic ring or a single bond; X is —OCO—(CH₂)ₘ—, —OCO—CH₂—O—, or —O—; and m is an integer of 0 to 6.

Another aspect of the present invention includes a production method of the ink-jet recording sheet, wherein at least one porous layer, comprising inorganic microparticles and a hydrophilic resin which undergoes cross-linking by ionization radiation, is coated onto a support; the concentration of solids of said porous layer is in the range of 5-90 percent; and drying is carried out after exposure to ionization radiation.

In order to solve the aforesaid problems, the inventors of the present invention conducted diligent investigations, and as a result, discovered the following. An ink-jet recording sheet, characterized in comprising a support coated thereon with at least one porous layer comprising inorganic microparticles and hydrophilic resins, which had undergone cross-linking by ionization radiation and the aforesaid hydrophilic resins which underwent cross-linking by ionization radiation were polyvinyl acetate ketone products comprising constitution units represented by aforesaid General Formula (1), resulted in preparation of a porous layer which minimized cracking during production and uniform coating quality and exhibited excellent ink absorbability, wet curl resistance, as well as folding and fracture resistance. Thus, the present invention was achieved.

### DETAILED DESCRIPTION OF EXEMPLARY EMBODIMENTS

The present invention will now be detailed.

Further embodiments of the present invention are as follows.

The ink-jet recording sheet of the present invention, wherein a polymerization degree of the mother nucleus PVA of the polyvinyl acetate saponification product is at least 400.

The ink-jet recording sheet of the present invention, wherein the cross-linking conversion ratio of the polyvinyl acetate saponification product is at most 4 mol percent.

The ink-jet recording sheet of the present invention, which comprises at least one water-soluble photoinitiator.

The ink-jet recording sheet of the present invention, wherein the support is non-water absorptive.

The ink-jet recording sheet of the present invention is prepared by applying onto a support a porous layer-forming water-based liquid coating composition which comprises a specified saponified polyvinyl acetate as well as microparticles so that a porous layer having voids is formed.

Employed as inorganic microparticles in the present invention are microscopic sized inorganic pigment particles of a large pore volume and a small average particle diameter. Specifically employed are microscopic pigment particles of materials such as silica, aluminum hydroxide, boehmite, pseudo-boehmite, alumina, and calcium carbonate.

Silica employed in the present invention refers to either wet process silica which is synthesized employing a precipitation method or a gelling method while employing sodium silicate as a raw material or gas phase method silica.

Examples of commercially available wet process silica include Fine Sil, manufactured by Tokuyama Ltd., as a precipitation method silica and NIGEL, manufactured by Nippon Silica Industrial Co., Ltd., as a gelling method silica. The precipitation method silica is characterized as silica particles which are prepared in such a manner that the secondary aggregates are formed employing primary particles at a size of about 10-about 60 nm, while the gelling method silica is characterized as silica particles which are prepared in such a manner that the secondary aggregates are formed employing primary particles at a size of about 3-about 10 nm.

The lower limit of the primary particle diameter of the wet process silica is not particularly limited. It is preferable that in view of production stability of silica particles, the resulting diameter is at least 3 nm and in view of transparency of the layer, the resulting diameter is at most 50 nm. Wet process silica, synthesized by employing the gelling method, is more preferred since generally, the resulting primary particle diameter tends to be smaller than that prepared by the precipitation method.

Gas phase method silica, as described herein, refers to one which is synthesized by a combustion method employing silicon tetrachloride and hydrogen as raw materials, and is commercially available, for example, under the Aerosil Series, manufactured by Nippon Aerosil Co., Ltd.

In order to prepare a porous ink receptive layer of a high void ratio, the specific surface area determined by the BET method is less than 400 m²/g or an isolated silanol group ratio prior to dispersion is preferably 0.5-2.0. A specific surface is preferably 40 to 100 m²/g. In view of realization of glossiness similar to silver salt photography, the lower limit of the specific surface area is preferably 40 m²/g. The BET method, as described in present invention, refers to the method which determines the specific surface area employing a method which obtains the surface area per g based on a gas phase adsorption isotherm.

Further, in the gas phase method silica having the specific surface area in this range, the variation coefficient in the primary particle size distribution is preferable 0.01 to 0.4 so as to achieve an appropriate void ratio. When the variation coefficient is more than 0.4, the void ratio becomes too small to realize the present invention. Incidentally, the aforesaid variation coefficient is not applicable to the wet process silica, since primary particles themselves exhibit pore diameter.

It is possible to obtain the isolated silanol group ratio in the present invention utilizing FT-IR. Namely, silica is dried at 120° C. for 24 hours and FT-IR of the dried silica is determined.

Specifically, silica powder is dried at 120° C. for 24 hours, and measurement is carried out by allowing a small amount of the aforesaid dried silica to adhere to a KRS-5 window plate. When silica is diluted with KBr, moisture in KBr reacts with the isolated silanol group. Consequently, determination is carried out without dilution. An infrared absorption spectrophotometer (FT-IR-4100, manufactured by JASCO Co.) is employed as a measurement apparatus and measurement in the range of 1000-4000 cm⁻¹ is carried out employing a transmission method. Subsequently, a base line is made by connecting absorbance obtained in such a manner that a 3746 cm⁻¹ peak assigned to the isolated silanol group is subjected to base line treatment via valley crossing, and each absorbance at the valley near 3750 cm⁻¹, the valley near 2120 cm⁻¹, and the valley near 1500 cm⁻¹, and absorbance at 1870 cm⁻¹ assigned to the stretching vibration of siloxane is then determined. The isolated silanol group ratio according to the present invention refers to the ratio of absorbance at 3746 cm⁻¹ assigned to Si—OH to absorbance at 1870 cm⁻¹ assigned to Si—O—Si, and is represented by the following formula.

Isolated silanol group ratio=absorbance at 3746 cm⁻¹/absorbsance at 1870 cm⁻¹

Incidentally, it is possible to control the isolated silanol group ratio related to the present invention by varying the moisture content of the aforesaid gas phase method silica.

Examples of methods to control the moisture content include a method to spray water vapor onto silica, a method to continuously spray water vapor onto silica during conveyance, and a method to spray, under aeration, water vapor onto silica which was charged into a tightly sealed batch. It is also preferable to control the moisture content of gas phase method silica by storing the aforesaid silica at a humidity of 20-60 percent for at least three days.

The gas phase method silica exhibits a feature in which its secondary aggregates can be dispersed employing lower energy compared to the wet process silica, since they are formed via weak interaction, compared to the wet process silica.

The variation coefficient in the primary particle size distribution of the gas phase method silica is determined as follows. A section or surface of a void layer is observed employing an electron microscope and the diameter of 1,000 random primary particles is determined. Subsequently, the aforesaid variation coefficient is obtained by dividing the standard deviation of the resulting particle size distribution by the number average particle diameter. Each particle diameter, as described herein, is represented by the diameter of the circle which has the same area as the projected area of each particle.

Further, the average diameter of the primary particles and the secondary particles, which are secondary aggregates, of silica is obtained in the same manner as above. Namely, the section or surface of a void layer is observed employing an electron microscope and the desired values are obtained based on the diameter of 100 random particles. Each particle diameter, as described herein, is represented by the diameter of the circle which has the same area as the projected area of each particle as described above. Further, in view of transmission of ionization radiation, the average diameter of secondary particles is preferably at most 300 nm.

Further, it is preferable to control the water content of gas phase method silica by storing the aforesaid silica at a humidity of 20-60 percent for at least three days.

The isolated silanol group ratio in the gas phase method silica used for the present invention is preferably 0.5-1.5, is more preferably 0.5-1.1.

Alumina used in the recording sheet of the present invention, as described herein, refers to aluminum oxide and hydrates thereof. Employed are those which are crystalline or non-crystalline, and amorphous, spherical, tabular, or acicular. Particularly preferred are tabular alumina hydrates at an aspect ratio of at least 2 and an average diameter of the primary particles of 5-30 nm, as well as gas phase method alumina.

The content of the aforesaid inorganic microparticles in a water-based liquid coating composition is commonly 5-40 percent by weight, and is particularly preferably 7-30 percent by weight.

The density of a solid portion in a porous layer containing inorganic microparticles and a hydrophilic resin which is cross-linked by irradiation with ionization radiation is preferably 5 to 90%.

A saponified polyvinyl acetate of the present invention is a resin which is cross-linked by ionization radiation such as with UV rays or electron beams. It is water soluble prior to hardening reaction but becomes practically insoluble after hardening reaction. However, it is preferable that the aforesaid resins maintain sufficient hydrophilicity to ink after cross-linking.

Employed as such resins may be cross-linking group-modified polymers which undergo cross-linking by radiation via a modifying group while polyvinyl alcohol and the like is subjected to action of a modifying group of a photodimerization type, a photodecomposition type, a photodepolymerization type, a photomodification type, or a photopolymerization type, and polymers which are subjected to direct cross-linking by electron beams. Of these, preferred are photodimerization or photopolymerization type compounds.

Listed examples of such polymers are those which are nonionic, cationic, and anionic. Polymers having a cationic or anionic portion in the structure are not preferred since cross-linking reaction is hindered due to interaction such as adsorption or repulsion of the cationic or anionic structure portion with the surface of inorganic fillers. Nonionic type hydrophilic binders which undergo cross-linking by ionization radiation, and especially resins disclosed in the aforesaid JP-A No. 2000-81062, are preferred since their interaction with inorganic microparticles is less than that of the cationic or nonionic type, whereby cross-linking reaction proceeds efficiently.

In the present invention, it is essential to use a saponified polyvinyl acetate having a unit represented by aforesaid General Formula (1).

In General Formula (1), R₁ is a hydrogen atom or a methyl group; n represents an integer of 1 or 2; Y is an aromatic ring or a single bond; X is —OCO—(CH₂)ₘ—, integer of 0-6.

Examples of units represented by General Formula (1) are as follows.

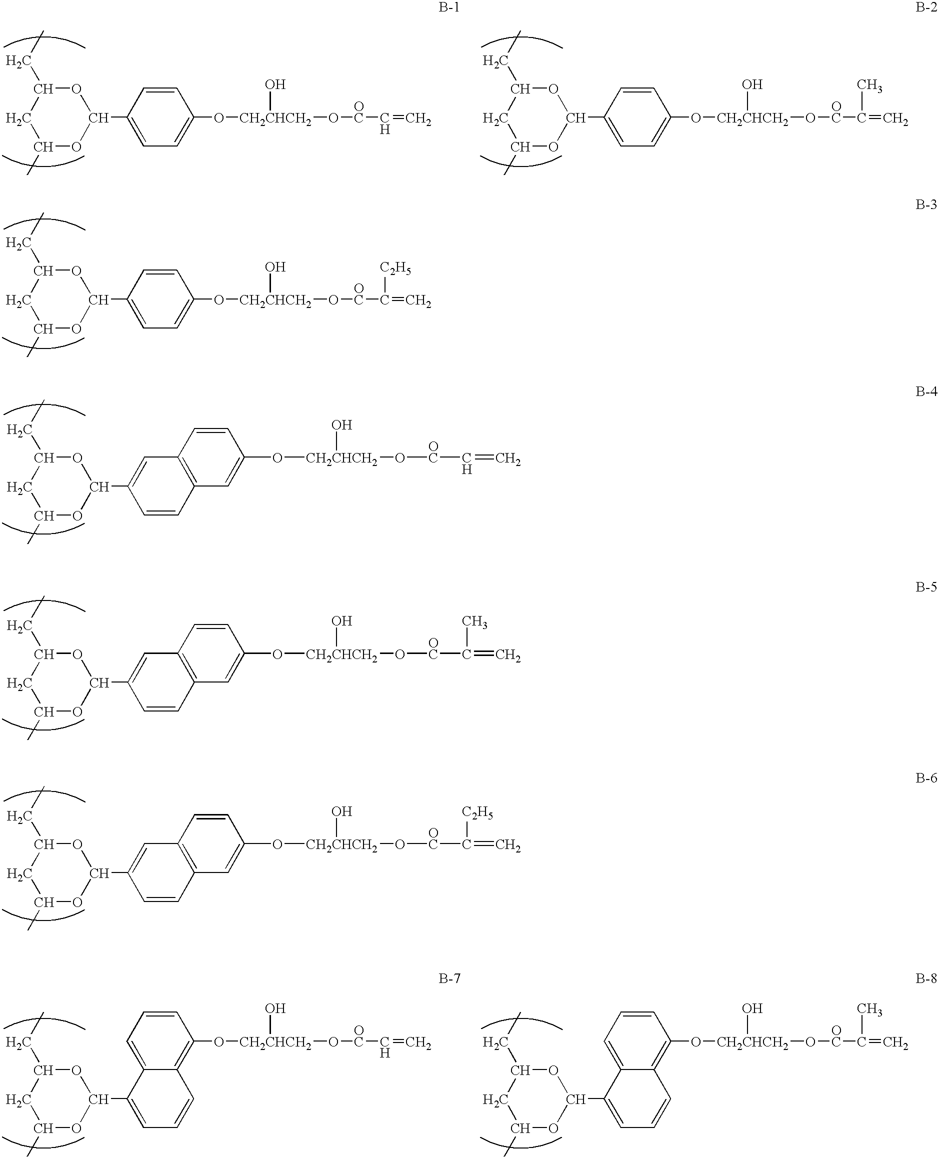

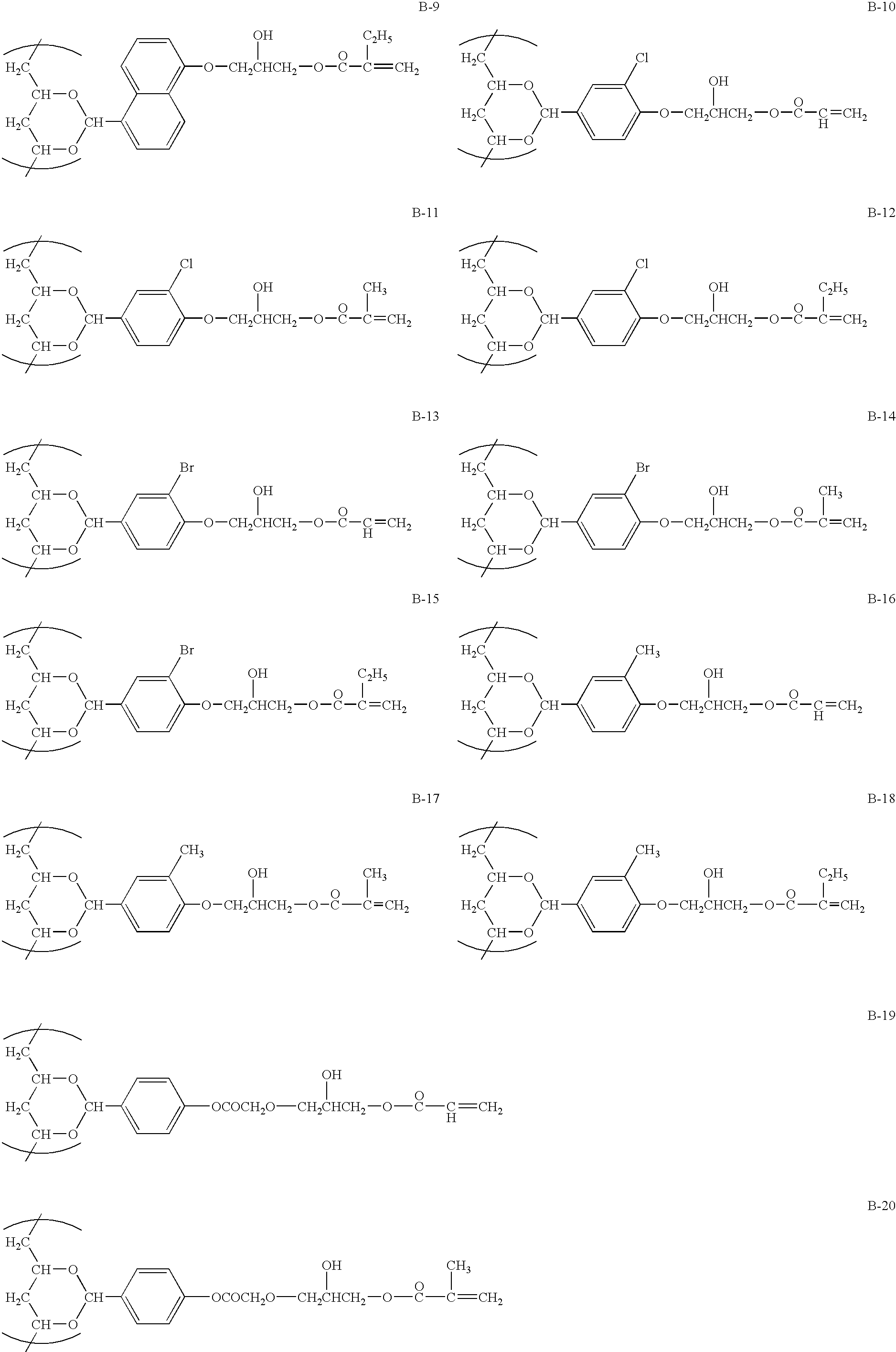

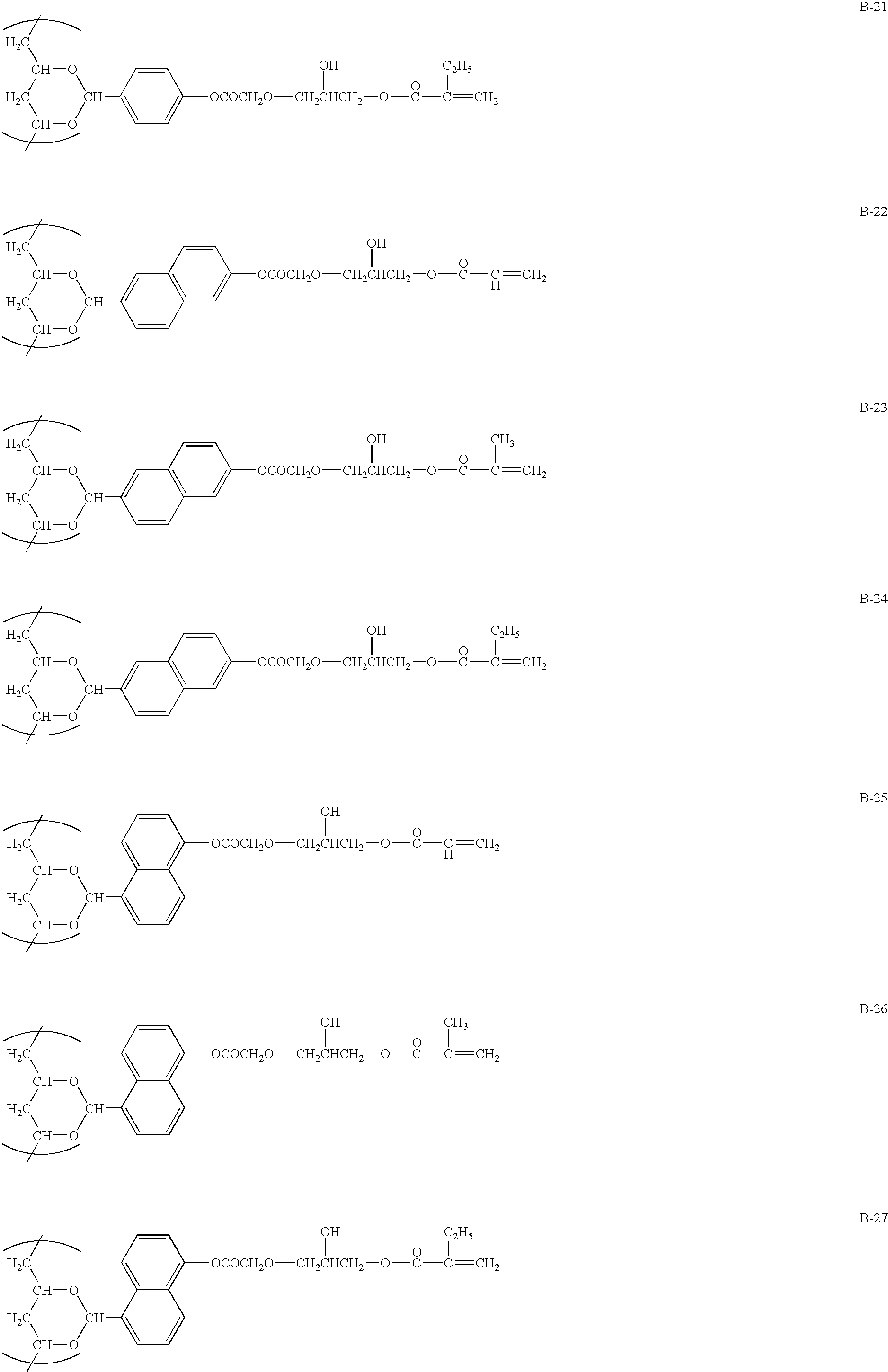

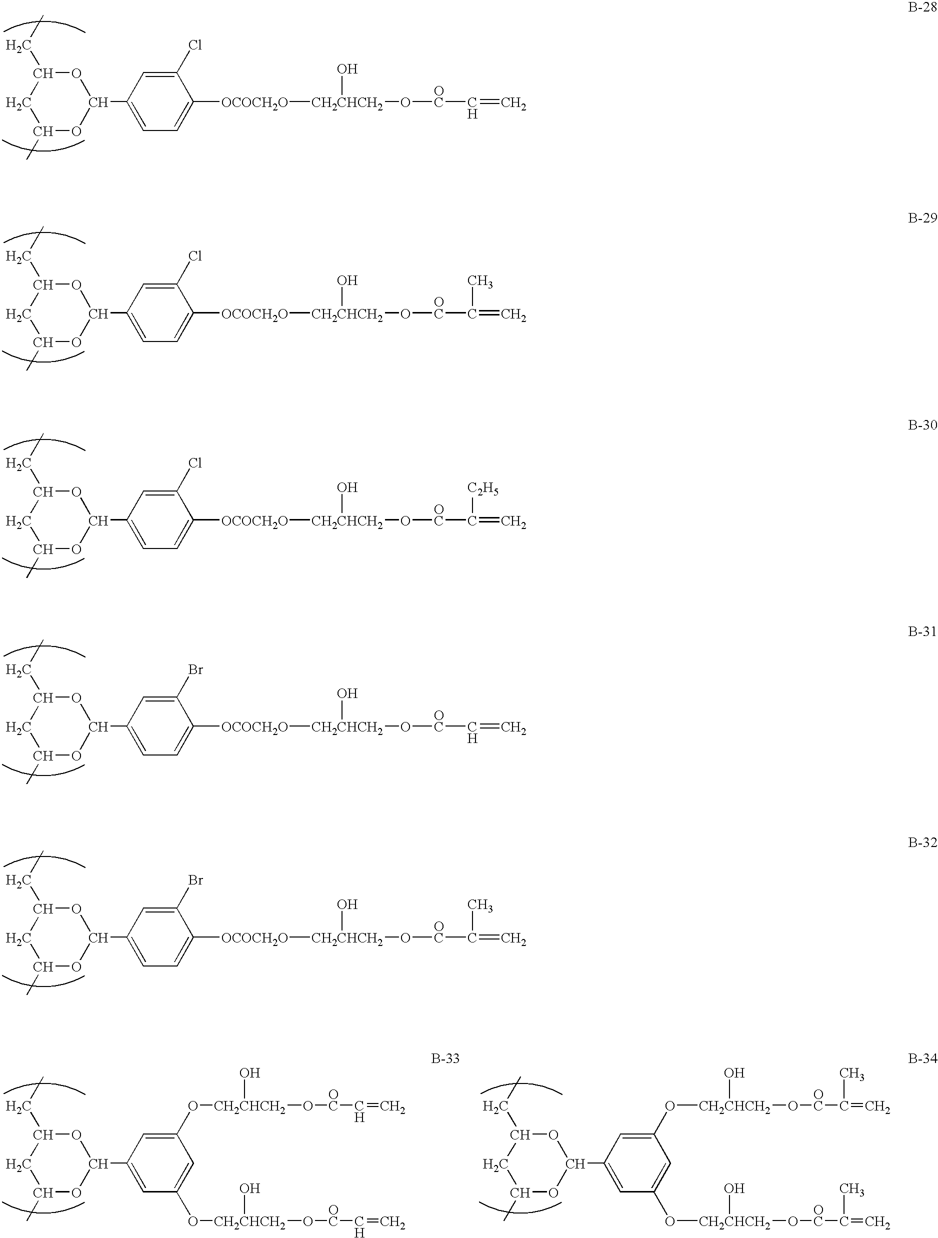

The degree of polymerization of the mother nucleus PVA of polyvinyl acetate saponification products according to the present invention is preferably in the range of 400-5,000, is more preferably in the range of 400-3,500, and is still more preferably in the range of 1,700-3,500. When the degree of polymerization is less than 400, sufficient coating strength is not achieved, while when it exceeds 5,000, the viscosity of the liquid coating composition increases excessively to degrade coating properties.

Further, the saponification ratio is preferably at least 60 percent, and is more preferably 70-100 percent, and still further preferably 88-100 percent. When the saponification ratio is less than 60 percent, cracking resistance which is one of the objectives of the present invention is not effectively exhibited.

It is possible to synthesize the polyvinyl acetate saponification products represented by General Formula (1) based on JP-A No. 2000-181062.

Further, the modification ratio of an ionization radiation reactive cross-linking group with respect to the segment is preferably at most 4 mol percent, and is more preferably 0.01-1 mol percent.

When the degree of polymerization of the segment is lees than 400 or the modification ratio exceeds 4 mol percent, the cross-linking density of the coating increases excessively whereby the folding and fracture resistance of the dried coating is markedly degraded. At the same time, excessively high cross-linking density is not preferred since curl resistance is degraded due to the imbalance between the substrate and the moisture absorbability as well as dimensional stability.

In the porous layer according to the present invention, the ratio of inorganic microparticles to cross-linked resin is preferably 2-50 times in terms of weight ratio. When the weight ratio is at least a factor of two, the void ratio of a porous layer is acceptable to tend to achieve the sufficient void volume, whereby it is possible to avoid sealing of voids due to swelling of an excessive cross-linked resin during ink-jet recording. On the other hand, an aforesaid ratio of at most a factor of 50 is preferable since cracking tends not to result when a relatively thick porous layer is coated. The ratio of silica microparticles to a cross-linked resin is particularly preferably 2.5-20 times. Further, in view of folding and fracture resistance of the coated layer, the aforesaid ratio is preferably a factor of 5-15.

It is preferable that the voids of the porous ink receptive layer according to the present invention have a volume of 15-40 ml/m² of the coated layer. The volume, as described herein, is defined by the volume of generated air bubbles when the coated layer at a unit volume is immersed in water, or the liquid transfer amount during 2-second contact time when a recording sheet is measured employing Liquid Absorption Test Method (the Bristow method) of Paper and Paper Board specified in J. TAPPI 51.

Employed as supports usable for the ink-jet recording sheet of the present invention may be water absorptive supports (for example, paper) as well as non-water absorptive supports. However, non-water absorptive supports are preferred since it is possible to prepare higher quality prints.

Listed as preferably employed non-water absorptive supports are, for example, polyester based film, diacetate based film, triacetate based film, polyolefin based film, acryl based film, polycarbonate based film, polyvinyl chloride based film, or polyimide based film, transparent film or opaque film comprised of materials such as cellophane or celluloid, or resin coated paper which is prepared by coating both sides of base paper with olefin resins, so-called RC paper.

When the aforesaid water-based liquid coating composition is applied onto the above-mentioned support, to increase the adhesion strength between the support surface and the coated layer, it is preferable that the support surface be subjected to corona discharge and subbing treatments. Further, the ink-jet recording sheet of the present invention may comprise a tinted support.

Supports preferably employed in the present invention include transparent polyester film, opaque polyester film, opaque polyolefin resin film, and a paper support in which both sides of the paper are laminated with polyolefin resins.

Non-water absorptive paper supports laminated with polyethylene, which is a representative of the most preferred polyolefin resins, will now be described.

Base paper employed for the paper support is made employing wood pulp as a main raw material and if desired, synthetic pulp such as polypropylene or synthetic fiber such as nylon or polyester together with the aforesaid wood pulp. Employed as the wood pulp may be, for example, any of LBKP, LBSP, NBKP, NBSP, LDP, NDP, LUKP, or NUKP. However, it is preferable to use LBKP, NBSP, LBSP, NDP, or LDP, all of which comprise a relatively large amount of short fibers. However, the ratio of LBSP or LDP is preferably 10-70 percent by weight.

Preferably employed as the aforesaid pulp is chemical pulp (sulfate pulp and sulfite pulp) with minimal impurities. Further, useful is pulp which is subjected to a bleaching treatment to enhance whiteness.

It is possible to suitably incorporate into base paper sizing agents such as higher fatty acids or alkyl ketene dimers, white pigments such as calcium carbonate, talc, or titanium oxide, paper strengthening agents such as starch, polyacrylamide, or polyvinyl alcohol, optical brightening agents, moisture retention agents such as polyethylene glycol, dispersing agents, and softening agents such as quaternary ammonium.

The freeness of pulp used for paper making is preferably 200-500 ml under the specification of CSF, while regarding fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 weight percent or less.

The basic weight of base paper is preferably 30-250 g, and is particularly preferably 50-200 g, while the thickness of the base paper is preferably 40-250 μm. Base paper may be given high smoothness employing calender finishing during or after paper making. The density of base paper is customarily 0.7-1.2 g/cm³ (in accordance with the method specified in JIS P 8118). Further, the stiffness of base paper is preferably 20-200 g under conditions specified in JIS P 8143. Surface sizing agents may be applied onto the surface of the base paper. Employed as surface sizing agents may be the same ones as those which can be incorporated into the base paper. The pH of base paper, when determined by the hot water extraction method specified in JIS P 8113, is preferably 5-9.

Polyethylene which is employed to cover the obverse and reverse surface of base paper is mainly comprised of low density polyethylene (LDPE) or high density polyethylene (HDPE). However, it is possible to use a combination of LLDPE and polypropylene.

It is preferable that opacity and whiteness of the polyethylene layer on the side coated with a porous layer are improved by incorporation of anatase type titanium oxide into polyethylene, as is widely employed in photographic paper. The proportion of titanium oxide is customarily 1-20 percent by weight with respect to polyethylene, and is preferably 2-25 percent by weight.

In the present invention, polyethylene coated paper is employed as a glossy paper. Further, it is possible to use polyethylene coated matte or silk surfaced paper, which is prepared as follows. When polyethylene is coated onto the surface of base paper employing melt extrusion, a matte or silk surface is formed on common photographic paper by employing so-called embossing treatments.

The amount of polyethylene used on the obverse and reverse sides of base paper is chosen so that the layer thickness of a water based liquid coating composition and curling under low humidity and high humidity after providing a back layer is optimized. In the present invention, the thickness of the polyethylene layer on the side coated with the water based coating composition is preferably in the range of 20-40 μm, while the thickness on the side coated with the back layer is preferably in the range of 10-30 μm.

Further, it is preferable that the aforesaid polyolefin coated paper supports exhibit the following characteristics.

1) Tensile strength: Strength specified in JIS P 8113 is preferably 2-300 N in the longitudinal direction and 10-200 N in the lateral direction,

2) Tear strength: Strength specified in JIS P 8116 is preferably 0.1-2 N in the longitudinal direction and 0.2-2 N in the lateral direction,

3) Compression modulus of elasticity: ≧1,030 N/cm,

4) Obverse side Bekk smoothness: At least 500 seconds under conditions specified in JIS P 8119 is preferable as a glossy surface, while that of so-called embossed products may be less than or equal to the above,

5) Reverse Side Bekk Smoothness: 100-800 seconds under conditions specified in JIS P 8119 are preferable,

6) Opacity: Under measurement conditions of a straight light incident/diffused light transmission, the transmittance of light in the visible region is preferably at most 20 percent and is particularly preferably at most 15 percent, and

7) Whiteness: Hunter whiteness specified in JIS P 8123 is preferably at least 80 percent. Further, when determined based on JIS Z 8722 (non-fluorescent objects) and JIS Z 8717 (containing fluorescent agents) and expressed by the color specification method specified in JIS Z 8730, L*, a* and b* are preferably 90-98, −5-+5, and −10-+5, respectively.

For improving adhesion to the porous ink receptive layer, it is possible to provide a sublayer on the porous ink receptive layer side of the aforesaid support. Binders of the sublayer are preferably hydrophilic polymers such as gelatin or polyvinyl alcohol and latex polymers at a Tg of −30 to 60° C. These binders are used in the range of 0.001-2 g per m² of the recording sheet. For an antistatic purpose, it is possible to incorporate into the sublayer a small amount of antistatic agents such as cationic polymers known in the art.

For the purpose of improving sliding properties and static charge characteristics, it is possible to provide a back layer on the side opposite the porous ink receptive layer side of the aforesaid support. Binders of the back layer are hydrophilic polymers such as gelatin or polyvinyl alcohol and latex polymers at a Tg of 30-60 ° C. Further, it is possible to incorporate antistatic agents such as cationic polymers, various kinds of surface active agents, and in addition, matting agents of an average particle diameter of about 0.5 - about 20 μm. The thickness of the back layer is commonly 0.1-1 μm, while when the back layer is provided to minimize curling, the aforesaid thickness is commonly in the range of 1-20 μm. Further, the back layer may be comprised of at least two layers.

It is preferable to carry out surface treatment such as corona discharge treatment or plasma treatment prior to coat a sublayer or a backing layer onto a support.

It is possible to incorporate various kinds of additives into a water-based liquid coating composition to form the porous layer according to the present invention. Listed as such additives are, for example, cationic mordants, cross-linking agents, surface active agents (for example, cationic, nonionic, anionic and amphoteric surface active agents), white background color controlling agents, optical brightening agents, antifungal agents, viscosity modifiers, low-boiling point organic solvents, high-boiling point organic solvents, latex emulsions, anti-discoloring agents, UV absorbers, multivalent metal compounds (water-soluble or water-insoluble), matting agents, and silicone oil. Of these, in view of improving water resistance and moisture resistance after printing, it is preferable to use cationic mordants.

Employed as cationic mordants are polymer mordants having a primary, secondary or tertiary amino group, or a quaternary ammonium salt group. Of these, polymer mordants having a quaternary ammonium salt group are preferred due to minimal discoloration as well as minimal degradation of light fastness during storage over an extended period of time.

Preferred polymer mordants are prepared in the form of homopolymers of monomers having the aforesaid quaternary ammonium salt group, or copolymers or condensation polymers with other monomers.

Employed as multivalent metal compounds usable in the present invention are, for example, sulfates, chlorides, nitrates, and acetates of Mg2+, Ca 2+, Zn 2+, Zr²⁺, Ni²⁺, and Al³⁺. Incidentally, inorganic polymer compounds such as basic polyaluminum hydroxide and zirconyl acetate are included in the examples of preferred water-soluble multivalent metal compounds. Many of these water-soluble compounds generally exhibit functions such as enhancement of light fastness, bleeding resistance, and water resistance. The amount of these water-soluble multivalent metal ions used is commonly in the range of 0.05-20 millimoles per m² of the recording sheet and is preferably in the range of 0.1-10 millimoles.

In the production of the ink-jet recording sheet of the present invention, a coating method employed for applying a porous layer liquid coating composition onto a support may suitably be selected from those known in the art. For example, preferably employed are a gravure coating method, a roller coating method, a rod bar coating method, an air knife coating method, a spray coating method, an extrusion coating method, a curtain coating method, and an extrusion coating method employing a hopper, described in U.S. Pat. No. 2,681,294.

The porous layer related to the recording sheet of the present invention is comprised of at least two layers. In view of enhancing productivity, a method is preferred in which all the constituting layers are coated simultaneously.

The production method of the ink-jet recording sheet of the present invention is characterized as follows. Hydrophilic binders which undergo cross-linking by ionization radiation are incorporated into the porous layer. After coating the aforesaid porous layer, aforesaid hydrophilic binders undergo cross-linking by exposure to ionization radiation. Thereafter, production is carried out by drying the resulting layer.

Ionization radiation, as described herein, refers to, for example, electron beams, ultraviolet radiation, α-rays, βrays, γ-rays, and X-rays. Of these, X-rays are preferred since they are less dangerous to humans, are easily handled, and are widely employed in industry.

Employed as light sources, for example, are low, middle, or high pressure mercury lamps having an operating pressure of several mmHg to about 10 mmHg, and metal halide lamps. In view of the wavelength range of light sources, a high pressure mercury lamp or a metal halide lamp is preferred, and of these, the metal halide lamp is particularly preferred. Further, it is preferable to arrange a filter to cut radiation of a wavelength of 300 nm or shorter. The output of lamps is preferably 400 W to 30 kW, while illuminance is preferably 10 mW/cm² to 1 kW/cm². In the present invention, radiation energy is preferably 0.1 to 150 mJ/cm , and is more preferably 1 to 50 mJ/cm².

Neither a case in which ultraviolet radiation of a wavelength of at most 300 nm is included in the wavelength of the light source, nor a case in which exposure energy exceeds 150 mJ/cm², is preferred due to the following reasons. The mother nucleus of ultraviolet radiation cross-linking resins or various simultaneously added additives may be decomposed by ultraviolet radiation, whereby the effects of the present invention are not realized and problems such as generation of unpleasant odors due to decomposed materials may occur. On the other hand, when exposure energy remains less than 0.1 mJ/cm2, cross-linking is not efficiently achieved, whereby the effects of the present invention are not also sufficiently exhibited.

Illuminance during exposure of ultraviolet radiation is preferably between 0.1 mW/cm² and 1 W/cm². When illuminance exceeds 1 W/cm², the coating surface is effectively cured, while deep portions are not cured sufficiently. As a result, a layer is prepared in which only the uppermost surface is hard. Such a case is not preferred since the resulting hardness in the depth direction is not balanced, whereby curling tends to occur.

Illuminance of at most 0.1 mW/cm² is also not preferred since cross-linking is not sufficient due to scattering in the layer, whereby the desired effects of the present invention are not exhibited.

In the case in which the same cumulative radiation amount (mJ/cm²) is irradiated, the fact that illuminance has a preferred range is due to variations of transmittance of the radiation used. The concentration distribution of generated cross-linking reaction species differs depending on the transmission of ultraviolet radiation. As a result, when the illuminance of ultraviolet radiation is high, cross-linking reaction species at high concentration is generated, whereby an undesirable hard and dense layer is formed on the coating surface.

In the case in which illuminance is in the preferred range, the degree of cross-linking is low at the layer surface and radiation is sufficiently transmitted into the depths, whereby a degree of cross-linking having a broad distribution is uniformly formed throughout the layer thickness.

In the case in which illuminance is excessively low, in order to provide the required cumulative illuminance, it is necessary to prolong the exposure time. This prolonged time is not preferable due to disadvantages in installment of facilities and shortage of the absolute radiation amount caused by scattering of ultraviolet radiation by the coating.

It is preferable that photopolymerization initiators and photosensitizers are incorporated into the ink-jet recording sheet of the present invention. These compounds may be in a state dissolved in solvents or in a dispersed state, or may be chemically combined with hydrophilic binders which undergo cross-linking by ionization radiation.

Photopolymerization initiators and photosensitizers usable in the present invention are not particularly limited, and any of those known in the art may be employed.

Preferable photopolymerization initiators and photosensitizers are those being water-soluble due to their high mixing property and high reaction efficiency.

Listed examples are: 4-(2-hydroxyethoxy)phenyl-(2-hydroxy-2-propyl)ketone(HMPK); thioxanthone ammonium salt(QTX); benzophenone ammonium salt(ABQ). In particular, 4-(2-hydroxyethoxy)phenyl-(2-hydroxy-2-propyl)ketone(HMPK) is preferable because of its high stability and high reaction efficiency.

Furhter examples are; benzophenones (e.g. benzophenone, hydroxybenzophenone, bis-N,N-dimethylaminobenzophenone, bis-N,N-diethylaminobenzophenone, and 4-methoxy-4′-dimethylaminobenzophenone); thioxanthones (e.g. thioxanthone, 2,4-diethylthioxanthone, isopropylthioxanthone, chlorothioxanthone, and isopropoxychlorothioxanthone); anthraquinones (e.g. ethylanthraquinone, benzanthraquinone, aminoanthraquinone, and chloroanthraquinone); acetophenones; benzoin ethers (e.g. benzoin methyl ether); 2,4,6-trihalomethyltriazines 1-hydroxycyclohexyl phenyl ketone; a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-phenylimidazole dimer, a 2-(o-methoxyphenyl)-4,5-phenylimidazole dimer, 2-(p-methoxyphenyl)-4,5-diphenylimidazole dimer, a 2,-di(p-methoxyphenyl)-5-phenylimodazole dimer, a 2,4,5-triarylimidazole dimer of 2-(2,4-dimethoxyphenyl)-4,5-diphenylimidazole dimer, benzyldimethylketal, 2-benzyl-2-dimethylamino-1-(4-morpholinophenyl)-butane, 2-methyl-1-[4-(methylthio)phenyl] -2-morpholino-1-propane, 2-hydoxy-2-methyl-1-phenyl-propane-1-one, 1-[4-(2-hydroxyethoxy)-phenyl]-2-hydroxy-2-methyl-1-propane-1-one, phenanthorenequinone, 9,10-phenanthorenequinone; benzoins (e.g. methylbenzoin and ethylbenzoin); acridine derivatives (e.g. 9-phenylacridine, 1,7-bis(9,9′-acridinyl)heptane); and bisacylphosphine oxide. The aforesaid compounds may be employed individually or in combinations.

In addition to the aforesaid photopolymerization initiators, it is possible to add polymerization accelerators. Listed as polymerization accelerators may be, for example, ethyl p-dimethylaminobenzoate, isoamyl p-dimethylaminobenzoate, ethanolamine, diethanolamine, and triethanolamine.

### EXAMPLES

The present invention will now be described with reference to examples. However, the present invention is not limited thereto. Incidentally, “%” in the examples is percent by weight, unless otherwise specified.

### Preparation of Inorganic Microparticle Dispersion S

While stirring at 3,000 rpm at room temperature, 40 g of Silica Dispersion B1 (at a pH of 2.6, and 0.5 percent ethanol), containing 30 percent previously uniformly dispersed gas phase method silica (Aerosil 300, manufactured by Nippon Aerosil Co., Ltd.) at an average primary particle diameter of approximately 0.007 μm, was added to 11 g of Aqueous Solution C-1 (at a pH of 2.5 and containing 2 g of Antifoaming Agent SN-381, manufactured by Sun Nopco Ltd.), containing 12 percent Cationic Polymer Dispersion P-1, 10 percent n-propanol, and 2 percent ethanol.

Subsequently, the resulting mixture was dispersed at a pressure of 3,000 N/cm², employing a high pressure homogenizer, manufactured by Sanwa Industry Co., Ltd. The total volume was controlled by adding pure water, so that nearly transparent Silica Dispersion S, containing 25 percent silica, was prepared.

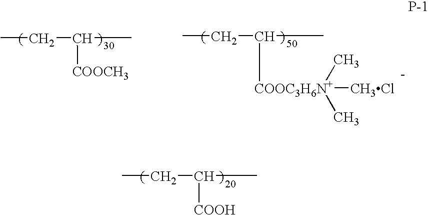

### Preparation of Recording Sheets

(1) Preparation of Recording Sheet No. 1

While stirring, gradually added to 100 g of Silica Dispersion S, prepared as above, were 32 g of a 10 percent aqueous solution of a polyvinyl acetate having a unit of B-2 (a degree of polymerization of the main chain PVA of 3,00 0, a saponification ratio of 88 percent, and a cross-linking modification ratio of 1 mol percent), and 0.5 g of a photoinitiator (Kayacure QTX, manufactured by Nippon Kayaku Co., Ltd.). The resulting mixture was made up to 200 g by the addition of pure water, whereby Liquid Coating Composition T-1 was prepared.

The resulting Liquid Coating Composition T-1 was filtered employing a TCP-10 Type filter manufactured by Advantechs Toyo Co., Ltd.

Subsequently, Liquid Coating Composition T-1, prepared as above, was applied, employing a bar coater, onto a polyethylene coated paper sheet (comprising 8 percent by weight anatase type titanium oxide in polyethylene on the ink absorptive layer side, a 0.05 g/m² gelatin sublayer on the ink receptive layer side, and a 0.2 g/m² back layer comprising a latex polymer at a Tg of about 80° C. on the opposite side), which was prepared by covering both sides of 170 g/m² weight base paper with polyethylene, to result in a coated silica amount of 26 g/m², . Thereafter, ultraviolet radiation at an energy level of 30 mJ/cm² was exposed onto the resulting coating, employing a metal halide lamp at a dominant wavelength of 365 nm. Subsequently, the exposed coating was dried employing an 80 ° C. hot air type oven, whereby Recording Sheet No. 1 was prepared.

(2) Preparation of Ink-jet Recording Sheet No. 2

Ink-jet Recording Sheet No. 2 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of a B-2 structure unit-containing polyvinyl acetate-saponified product (at a degree of polymerization of the main chain PVA of 1,700, a saponification ratio of 99 percent, and a cross-linking group modification ratio of 1 mol percent), and Kayacure QTX, manufactured by Nippon Kayaku Co., Ltd., was replaced with Irugacure 2959, manufactured by Ciba Specialty Chemicals Inc.

(3) Preparation of Ink-jet Recording Sheet No. 3

Ink-jet Recording Sheet No. 3 was prepared in the same manner as Ink-jet Recording Sheet No. 2, except that the 10 percent aqueous solution of a B-2 structure unit-containing polyvinyl acetate-saponified product (at a degree of polymerization of the main chain PVA of 1,700, a saponification ratio of 99 percent, and a cross-linking group modification ratio of 1 mol percent) was replaced with a 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 2.2 mol percent).

(4) Preparation of Ink-jet Recording Sheet No. 4

Ink-jet Recording Sheet No. 4 was prepared in the same manner as Ink-jet Recording Sheet No. 2, except that the 10 percent aqueous solution of a B-2 structure unit-containing polyvinyl acetate-saponified product (at a degree of polymerization of the main chain PVA of 1,700, a saponification ratio of 99 percent, and a cross-linking group modification ratio of 1 mol percent) was replaced with a 10 percent aqueous solution of a B-4 structure unit-containing polyvinyl acetate-saponified product (at a degree of polymerization of the main chain PVA of 1,700, a saponification ratio of 99 percent, and a cross-linking group modification ratio of 2.2 mol percent).

(5) Preparation of Ink-jet Recording Sheet No. 5

Ink-jet Recording Sheet No. 5 was prepared in the same manner as Ink-jet Recording Sheet No. 2, except that the 10 percent aqueous solution of a B-2 structure unit-containing polyvinyl acetate-saponified product (at a degree of polymerization of the main chain PVA of 1,700, a saponification ratio of 99 percent, and a cross-linking group modification ratio of 1 mol percent) was replaced with a 10 percent aqueous solution of a B-20 structure unit-containing polyvinyl acetate-saponified product (at a degree of polymerization of the main chain PVA of 1,700, a saponification ratio of 99 percent, and a cross-linking group modification ratio of 1.6 mol percent).

(6) Preparation of Ink-jet Recording Sheet No. 6

Ink-jet Recording Sheet No. 6 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of a B-2 structure unit-containing polyvinyl acetate-saponified product (at a degree of polymerization of the main chain PVA of 400, a saponification ratio of 88 percent, and a cross-linking group modification ratio of 4.5 mol percent).

(7) Preparation of Ink-jet Recording Sheet No. 7

Ink-jet Recording Sheet No. 7 was prepared in the same manner as Ink-jet Recording Sheet No. 2, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of a B-20 structure unit-containing polyvinyl acetate-saponified product (at a degree of polymerization of the main chain PVA of 400, a saponification ratio of 88 percent, and a cross-linking group modification ratio of 4.2 mol percent).

(8) Preparation of Ink-jet Recording Sheet No. 8

Ink-jet Recording Sheet No. 8 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of “a” structure unit-containing anionic photodimerization type PVA (at a degree of polymerization of the main chain PVA of 3,000, a saponification ratio of 88 percent, and a cross-linking group modification ratio of 1 mol percent), and the liquid coating composition was re-dispersed employing a sand mill.

(9) Preparation of Ink-jet Recording Sheet No. 9

Ink-jet Recording Sheet No. 9 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of “b” structure unit-containing anionic photodimerization type PVA (at a degree of polymerization of the main chain PVA of 3,000, a saponification ratio of 88 percent, and a cross-linking group modification ratio of 1 mol percent), and the liquid coating composition was re-dispersed employing a sand mill.

(10) Preparation of Ink-jet Recording Sheet No. 10

Ink-jet Recording Sheet No. 10 was prepared in the same manner as Ink-jet Recording Sheet No. 1, except that ultraviolet radiation exposure was not employed.

(11) Preparation of Ink-jet Recording Sheet No. 11

Ink-jet Recording Sheet No. 11 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous PVA (at a degree of polymerization of the main chain PVA of 3,000 and a saponification ratio of 88 percent) solution.

(12) Preparation of Ink-jet Recording Sheet No. 12

Ink-jet Recording Sheet No. 12 was prepared in the same manner as Ink-jet Recording Sheet No. 1, except that the 10 percent aqueous solution of a B-2 structure unit-containing polyvinyl acetate-saponified product (at a degree of polymerization of the main chain PVA of 3,000, a saponification ratio of 88 percent, and a cross-linking group modification ratio of 1 mol percent) was replaced with a 10 percent aqueous solution of PET-30 (pentaerythritol acrylate), manufactured by Nippon Kayaku Co., Ltd.

(13) Preparation of Ink-jet Recording Sheet No. 13

Ink-jet Recording Sheet No. 13 was prepared in the same manner as Ink-jet Recording Sheet No. 2, except that the 10 percent aqueous solution of a B-2 structure unit-containing polyvinyl acetate-saponified product (at a degree of polymerization of the main PVA of 1,700, a saponification ratio of 99 percent, and a cross-linking group modification ratio of 1 mol percent) was replaced with a 10 percent aqueous solution of a “c” structure unit containing resin (at a degree of polymerization of the main chain PVA of 500, and a cross-linking group modification ratio of 20 mol percent).

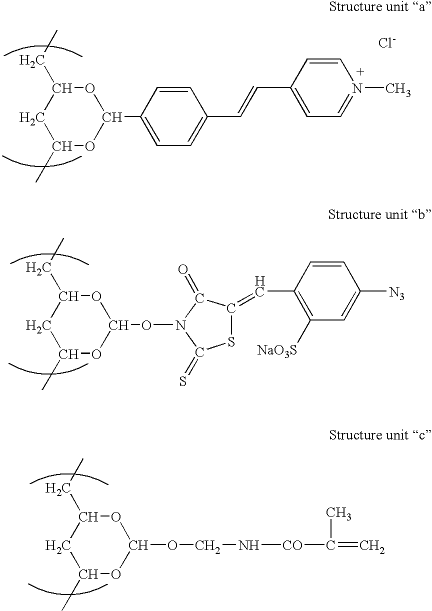

Recording sheets Nos. 1-13 prepared as above were stored at 40° C. for 3 days, and thereby stabilized.

### Characteristic Evaluation of Recording Sheets

Each of the recording sheets prepared as above was evaluated for layer surface appearance, ink absorbability, image bleeding, folding and fracture resistance, and dimension stability based on the methods described below. Table 1 shows the results.

(Layer Surface Appearance)

Visually, the smoothness of the layer surface was evaluated, while the number of cracks per 10 cm² of the layer surface was recorded.

(Ink Absorbability)

Solid images, each image having 255^{th} output level (maximum density) of cyan and yellow, were printed employing an ink-jet printer PM900C, manufactured by Seiko Epson Corp., and presence of unevenness was visually evaluated at 10 rankings based on the criteria below.

1: no unevenness was noted

2: slight unevenness was noted when attentively observed, but was commercially viable

3: unevenness having a dot shape was noted, but was commercially viable

4: unevenness was clearly noted, but was commercially viable

5: unevenness was clearly noted, but was commercially viable depending on the kinds of images printed

6: unevenness of color was noted and was at a commercially unviable level

7: sea-island pattern caused by over-flew ink was observed and was at a commercially unviable level

8: ink was over flew and color turbidity were observed, and was at a commercially unviable level

9: over-flew ink was hard to be dried, and was at a commercially unviable level

10: cannot acceptable at all for commercial use

In the aforesaid rankings, a rank of 6 or larger figure was judged to be commercially unviable.

(Image Bleeding)

Employing an ink-jet printer PIXAS900, manufactured by Canon Corp., 0.5 mm wide black fine lines on the background of a magenta image portion were printed. After storing the resulting prints at 40° C. and 80 percent relative humidity for 7 days, the line width was measured employing a microdensitometer, and any increase ratio of the line width was denoted as bleeding.

(Folding and Fracture)

A 5 mm×10 cm strip which was prepared by cutting the recording sheet was wound around a cardboard core of a core interior diameter of 3 cm, and cracks due to folding and fracture were visually evaluated based on the following 5 rankings.

A: neither folds nor fractures were noted

B: a maximum of 3 folds and factures were noted

C: 4-10 of folds and fractures were noted

D: 11-20 folds and fractures were noted

E: 21-100 folds and fractures were noted

F: at least 101 of folds and fractures were noted

In the aforesaid rankings, rankings of E and F was judged to be commercially unviable.

(Dimensional stability)

Each recording sheet was cut into A4 size sheets, and the cut sheets were placed on a horizontal surface at 23° C. and 20 percent relative humidity for one day. Thereafter, the height (mm) of curl (rise from the supporting surface) at the four corners was determined and the average value (mm) of the four corners was calculated. Dimensional stability was then evaluated based on the criteria below.

A: the average height was less than 3 mm

B: the average height was between 3 and 5 mm

C: the average height was between 6 and 10 mm

D: the average height was between 11 and 30 mm

E: the average height was at least 31 mm

F: the recording sheet was cylindrical, whereby it was impossible to achieve measurements

TABLE 1

| Recording | Layer | | | Folding | | |
|---|---|---|---|---|---|---|
| Sheet | Surface | Ink Absorb- | Image | and | Dimensional | |
| No. | Appearance | ability | Bleeding | Fracture | Stability | Remarks |
| 1 | 0 | 1 | 1.1 | A | B | Inv. |
| 2 | 0 | 1 | 1.0 | A | A | Inv. |
| 3 | 0 | 2 | 1.1 | B | B | Inv. |
| 4 | 0 | 1 | 1.2 | A | A | Inv. |
| 5 | 0 | 2 | 1.2 | B | B | Inv. |
| 6 | 0 | 2 | 1.1 | B | B | Inv. |
| 7 | 0 | 2 | 1.1 | D | C | Inv. |
| 8 | 5 | 5 | 1.4 | D | C | Comp. |
| 9 | 11 | 6 | 3.2 | B | C | Comp. |
| 10 | 163 | 10 | 2.2 | F | D | Comp. |
| 11 | 182 | 10 | 2.4 | F | E | Comp. |
| 12 | 18 | 3 | 1.6 | F | F | Comp. |
| 13 | 20 | 5 | 1.9 | E | E | Comp. |

Inv.: Invention, Comp.: Comparison

From the above table, it is clearly seen that the embodiments of the present invention result in an excellent layer surface state, excellent ink absorbability, minimized image bleeding, and enhanced folding and fracture resistance compared to the comparative examples.

Based on the present invention, it is possible to provide an ink-jet recording sheet having a porous layer which tends to not form cracking during production and exhibits excellent ink absorbability, minimized image bleeding, and enhanced folding and fracture resistance, as well as a production method thereof.

What is claimed is:

1. An ink-jet recording sheet comprising a support having thereon a porous ink receptive layer which contains inorganic microparticles and a cross-linked resin,
wherein the porous ink receptive layer is prepared by a method comprising the steps of:
(a) coating a liquid coating composition on the support to obtain a coated layer, the liquid coating composition containing a saponified polyvinyl acetate having a unit represented by General Formula (1) in the molecule, 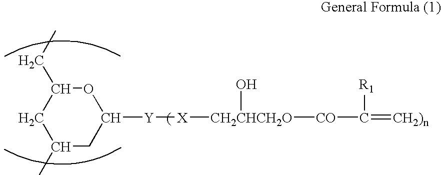
wherein R₁ is a hydrogen atom or a methyl group; n is an integer of 1 or 2; Y is an aromatic ring or a single bond; X is —OCO—(CH₂)ₘ—, —OCO—CH₂—O—, or —O—; and m is an integer of 0 to 6;
(b) irradiating the saponified polyvinyl acetate in the coated layer with ionization radiation to obtain the cross-linked resin; and
(c) drying the coated layer.

2. The ink-jet recording sheet of claim 1, wherein a polymerization degree of polyvinyl alcohol in the saponified polyvinyl acetate is not less than 400.

3. The ink-jet recording sheet of claim 1, after the step (b), a ratio of cross-linking conversion of the saponified polyvinyl acetate is not more than 4 mol % based on the total mol of the saponified polyvinyl acetate in the coated layer.

4. The ink-jet recording sheet of claim 1, wherein the liquid coating composition further contains a water-soluble photoinitiator.

5. The ink-jet recording sheet of claim 1, wherein the support is a non-absorptive support.

6. An ink-jet recording sheet comprising a support having thereon a porous ink receptive layer which contains inorganic microparticles and a cross-linked resin,
wherein the porous ink receptive layer is prepared by a method comprising the steps of:
(a) coating a liquid coating composition on the support to obtain a coated layer, the liquid coating composition containing a saponified polyvinyl acetate having a unit represented by General Formula (1) in the molecule, 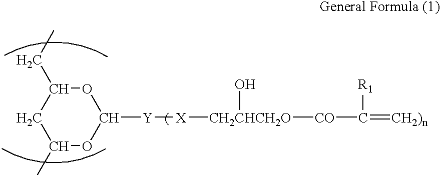
wherein R₁ is a hydrogen atom or a methyl group; n is an integer of 1 or 2; Y is an aromatic ring or a single bond; X is —OCO—(CH₂)ₘ—, —OCO—CH₂—O—, or —O—; and m is an integer of 0 to 6,
a polymerization degree of polyvinyl alcohol in the saponified polyvinyl acetate being not less than 400;
(b) irradiating the saponified polyvinyl acetate in the coated layer with ionization radiation to obtain the cross-linked resin, a ratio of cross-linking conversion of the cross-linked resin being not more than 4 mol % based on the total mol of the saponified polyvinyl acetate in the coated layer; and
(c) drying the coated layer.

7. The ink-jet recording sheet of claim 6, wherein the liquid coating composition further contains a water-soluble photoinitiator.

8. The ink-jet recording sheet of claim 6, wherein the support is a non-absorptive support.

9. A method for producing an ink-jet recording sheet comprising the steps of:
(a) coating a liquid coating composition on a support so as to obtain a coated layer, the liquid coating composition containing,
(i) inorganic microparticles; and
(ii) a hydrophilic resin;
(b) irradiating the coated layer with ionization radiation so as to cross-link the hydrophilic resin when a density of a solid portion in the coated layer is in a range of 5 to 90 weight % based on the total weight of the coated layer; and
(c) drying the coated layer so as to obtain a porous ink receptive layer,
wherein the hydrophilic resin is a saponified polyvinyl acetate having a unit represented by General Formula (1) in the molecule, 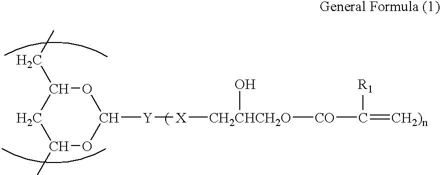
wherein R₁ is a hydrogen atom or a methyl group; n is an integer of 1 or 2; Y is an aromatic ring or a single bond; X is —OCO—(CH₂)ₘ—, —OCO—CH₂—O—, or —O—; and m is an integer of 0 to 6.

10. The method for producing an ink-jet recording sheet of claim 9, wherein a polymerization degree of polyvinyl alcohol in the saponified polyvinyl acetate is not less than 400.

11. The method for producing an ink-jet recording sheet of claim 9, after the step (b), a ratio of cross-linking conversion of the cross-linked resin is not more than 4 mol % based on the total mol of the saponified polyvinyl acetate in the coated layer.

12. The method for producing an ink-jet recording sheet of claim 9, wherein the liquid coating composition further contains a water-soluble photoinitiator.

13. The method for producing an ink-jet recording sheet of claim 9, wherein the support is a non-absorptive support.

14. A method for producing an ink-jet recording sheet comprising the steps of:
(a) coating a liquid coating composition on a support so as to obtain a coated layer, the liquid coating composition containing,
(i) inorganic microparticles; and
(ii) a hydrophilic resin;
(b) irradiating the coated layer with ionization radiation so as to cross-link the hydrophilic resin when a density of a solid portion in the coated layer is in a range of 5 to 90 weight % based on the total weight of the coated layer; and
(c) drying the coated layer so as to obtain a porous ink receptive layer,
wherein the hydrophilic resin is a saponified polyvinyl acetate having a unit represented by General Formula (1) in the molecule, 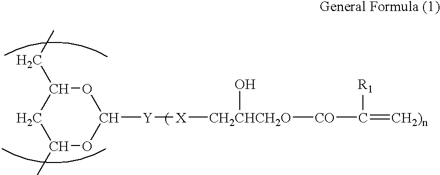
wherein R₁ is a hydrogen atom or a methyl group; n is an integer of 1 or 2; Y is an aromatic ring or a single bond; X is —OCO—(CH₂)ₘ—, —OCO—CH₂—O—, or —O—; and m is an integer of 0 to 6,
a polymerization degree of polyvinyl alcohol in the saponified polyvinyl acetate being not less than 400, and after the step (b), a ratio of cross-linking conversion of the saponified polyvinyl acetate is not more than 4 mol % based on the total mol of the saponified polyvinyl acetate in the coated layer.

15. The method for producing an ink-jet recording sheet of claim 14, wherein the liquid coating composition further contains a water-soluble photoinitiator.

16. The method for producing an ink-jet recording sheet of claim 15, wherein the support is a non-absorptive support.
